(19) United States
(12) Patent Application Publication
(10) Pub. No.: US 2011/0091047 A1
(43) Pub. Date: Apr. 21, 2011

(54) Active Noise Control in Mobile Devices

(76) Inventors: Alon Konchitsky, Santa Clara, CA (US); Yaniv Konchitchki, Los Angeles, CA (US); Sandeep Kulakcherla, Santa Clara, CA (US); Alberto D. Berstein, Cupertino, CA (US)

(21) Appl. No.: 12/907,886

(22) Filed: Oct. 19, 2010

Related U.S. Application Data
(60) Provisional application No. 61/253,366, filed on Oct. 20, 2009.

(51) Int. Cl. G10K 11/16

(52) U.S. Cl. 381/71.11; 381/71.6

(57) ABSTRACT

A three dimensional area of quiet is created by an active noise cancellation system comprising a reference microphone receiving background noise and sending the noise signal to an adaptive active noise canceller. An adaptive filter system using weights updated by a least mean squares method or other method generates an anti-phase signal which is broadcasted to counteract the background noise. The resulting residual noise or residual signal is sent back to the adaptive active noise canceller to reset the weights of the adaptive filter.

### RELATED PATENT APPLICATION AND INCORPORATION BY REFERENCE

This is a utility application based upon U.S. patent application Ser. No. 61/253,366 “Active Noise Control in Mobile Devices” filed on Oct. 20, 2009. This related application is incorporated herein by reference and made a part of this application. If any conflict arises between the disclosure of the invention in this utility application and that in the related provisional application, the disclosure in this utility application shall govern. Moreover, the inventor(s) incorporate herein by reference any and all patents, patent applications, and other documents hard copy or electronic, cited or referred to in this application.

References Cited

| | | |
|---|---|---|
| US 2007/0160223 A1 | July 2007 | Cusack Jr |
| U.S. Pat. No. 5,862,234 | January 1999 | Todter et al |
| U.S. Pat. No. 5,033,082 | July 1991 | Eriksson et al |

### OTHER REFERENCES

[1] Sen M. Kuo & Dennis R. Morgan, “Active Noise Control Systems—Algorithms and DSP Implementations”, Wiley publications.

### BACKGROUND OF THE INVENTION

(1) Field of the Invention

The present invention relates to means and methods of providing clear, high quality local experience, in voice communication systems, devices, telephones, and methods, and more specifically, to systems, devices, and methods that automate control in order to correct for variable environment noise levels and reduce or cancel the environment noise using mobile devices before it reaches the ear.

This invention is the field of processing signals in cell phones, mobile phones, mono aural headsets and Bluetooth headsets etc. In general, it more relates to any device which has a microphone and a loud speaker and used in different environments where improving the local listening experience is desired. Hereinafter cell phones, mobile phones, mono aural headsets, Bluetooth headsets are referred as mono aural voice communication devices.

Mono aural voice communication devices such as cell phones, wireless phones, Bluetooth headsets and devices other than cell phones have become ubiquitous; they show up in almost every environment. These systems and devices and their associated communication methods are referred to by a variety of names, such as but not limited to, cellular telephones, cell phones, mobile phones, wireless telephones in the home and the office, and devices such as Personal Data Assistants (PDA^{s}) that include a wireless or cellular telephone communication capability. They are used at home, office, inside a car, a train, at the airport, beach, restaurants and bars, on the street, and almost any other venue. As might be expected, these diverse environments have relatively higher and lower levels of background, ambient, or environmental noise. For example, there is generally less noise in a quiet home than there is in a crowded bar.

Significantly, in an on-going cell phone call or other communication from an environment having relatively higher environmental noise, it is sometimes difficult for the party in the noisy environment hear the other end because of the local background noise.

(2) Description of the Related Art

Traditionally, local ambient noise cancelling involves active or passive noise reduction techniques or sometimes a combination of both. Passive noise reduction techniques either change the impedance to silence the ambient noise or use a sound-absorbing material so that the ambient noise loses its energy [1].

Several attempts to reduce the local ambient noise are known in the related art. US patent application 2007/0160223 A1 assigned to Cusack Jr talks about active noise cancelling using a stereo headphone arrangement. However, this technique employs the noise cancelling technology in a USB connector fob and a stereo cup arrangement which may not be available in mono aural headsets, cell phones, mobile phones, Bluetooth headsets etc.

U.S. Pat. No. 5,033,082 assigned to Eriksson et al also discloses active noise cancellation in communication systems. However, the technology is limited to environments like medical imaging systems with hollow tunnels and inside motor vehicles where there is a room for using large speakers and maintaining a good distance between a loud speaker and a reference microphone. In mono aural headsets, cell phones etc, due to space constraints the distance between a loud speaker, a reference microphone, and a error microphone is very small.

U.S. Pat. No. 5,862,234 assigned to Todter et al discloses a bilateral transducer which converts acoustic waves to electrical signals and vice versa. However, using a bilateral transducer in a mobile device can be expensive and not needed as mobile devices have one or more microphones.

Passive noise cancellers with large cups that completely cover the ear are most effective against ambient noise. However, these are bulky, expensive and ineffective at low frequencies [1].

On the contrary, active noise cancellers inject an opposite signal relative to the interfering ambient noise, thereby minimizing the resulting sound reaching the ear.

A microphone which is very close to the ear is used to pick up the ambient noise. This signal is then processed using DSP techniques to produce an opposite signal which is played back through a secondary speaker in the headphone. The signal from the secondary speaker interferes and cancels the noise from the original primary source before it reaches the ear. The resultant noise level detected by the listener is considerably reduced.

Most of the techniques available today for noise cancellation and noise reduction are not effective and are prone to performance degradation at higher frequencies. The direction of the noise also has a considerable effect on such techniques.

Hence there is a need in the art for a method of active noise reduction or cancellation that is robust, suitable for mobile use, and inexpensive to manufacture. An objective of the current invention is to provide the means to implement active noise cancellation systems in mono aural voice communication devices to create a 3D or three dimensional—silence zone and improved local listening experience.

There are several methods for performing noise reduction, but all can be categorized as types of filtering. In the related art, speech and noise are mixed into one signal channel, where they reside in the same frequency band and may have similar correlation properties. Distinguishing between voice and background noise signals is a challenging task. Speech components may be perceived as noise components and may be suppressed or filtered along with the noise components.

It is an objective of the present invention to provide methods and devices that overcome disadvantages of prior art active noise cancellation schemes. The methods should be computationally inexpensive, ability to detect and reduce different levels of background noise in various environments.

### SUMMARY OF THE INVENTION

The present invention provides a novel system and method for monitoring the noise in the environment (near end) in which a mono aural voice communication device is operating and cancels the environmental noise before it reaches the ear of the person in the near end to create a 3D—silence zone effect so that the user feels he is in a quiet environment.

The present invention preferably employs noise reduction and/or cancellation technology that is operable to attenuate or even eliminate noise portions of an audio spectrum. By monitoring the ambient or environmental noise in the location in which the mono aural voice communication device is operating and applying noise reduction and/or cancellation protocols at the appropriate time via digital signal processing, it is possible to significantly reduce the ambient or background noise to which a party might be subjected to.

In one aspect of the invention, the invention provides a system and method that enhances the convenience of using a cellular telephone, mobile phone, mono headset, Bluetooth headset or other wireless telephone or communications device, even in a location having relatively loud background noise.

In another aspect of the invention, the invention provides a system and method for canceling ambient or environmental noise before the background noise reaches the near-end person's ear and improves the local experience.

In yet another aspect of the invention, the invention monitors the local background noise via a microphone and thereafter cancels it by sending an opposite signal via a secondary speaker.

In still another aspect of the invention, an enable/disable switch is provided on a cellular telephone device to enable/disable the active noise cancellation.

These and other aspects of the present invention will become apparent upon reading the following detailed description in conjunction with the associated drawings. The present invention overcomes shortfalls in the related art by combining microphone(s) with an adaptive noise cancellation algorithm. These modifications, other aspects and advantages will be made apparent when considering the following detailed descriptions taken in conjunction with the associated drawings.

### BRIEF DESCRIPTION OF THE DRAWINGS

FIG. 1 shows the prior art and the basic principle of an active noise cancellation system.

FIG. 2 is diagram of an exemplary embodiment of the active noise cancellation scheme.

FIG. 3a is a diagram showing the 3D—silence zone that is created for a voice communication device to have a pleasant conversation and give the user a feeling that he is in a quiet zone despite being in a car noise environment.

FIG. 3b is a diagram showing the 3D—silence zone that is created for a voice communication device to have a pleasant conversation and give the user a feeling that he is in a quiet zone despite being in an airport noise environment.

FIG. 3c is a diagram showing the 3D—silence zone that is created for a voice communication device to have a pleasant conversation and give the user a feeling that he is in a quiet zone despite being in an office noise environment.

FIG. 3d is a diagram showing the 3D—silence zone that is created for a voice communication device to have a pleasant conversation and give the user a feeling that he is in a quiet zone despite being in a restaurant noise environment.

FIG. 4 is a diagram of an exemplary embodiment of the adaptive filter.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Ambient noise is a major problem when processing audio signals. It is usually caused by fans, engines, blowers, air conditioners etc. Ambient noise can also be experienced in airplanes, helicopters, cars etc. If untreated, this noise can be annoying at times. Active Noise Cancelling headphones have always been popular among travelers, office workers, music listeners etc. In many cases, it is possible to mitigate it and enhance the performance because of their “stereo cup” nature which covers both the ears. These solutions cannot be directly applied to mobile devices, cell phones, mono aural headsets and Bluetooth headsets where the listening is “mono” and the other ear is exposed to the local background noise. To cope with this problem, we can process the signal in a Digital Signal Processor (DSP). The noisy signal is picked up by the microphone and fed to the DSP for analysis and local ambient noise reduction to improve the local experience.

Most of noise reduction algorithms are based on the assumption that the interfering noise is stationary (HVAC, projector noise, engine noise etc) or slowly varying compared with speech (Car noise). These kinds of noises have energies spread evenly in a frequency range or have energy concentrated at specific frequencies [1]. But mobile devices operate in different environments and encounter different kinds of noises which are spread over a wide frequency range (restaurant noise, street noise etc). An efficient noise cancelling algorithm for mobile devices is discussed here where in the local background noise is analyzed and a 3D—silence zone is created at the near-end person's ear to create a feeling that he is in a quiet environment. The near-end person's ear where the device is held against is herein after referred as busy ear. The other ear of the near-end speaker is referred as free ear.

The present invention provides a novel and unique background noise or environmental noise reduction and/or cancellation feature for a communication device such as a cellular telephone, wireless telephone, cordless telephone, recording device, a handset, mono aural headset, Bluetooth headset and other communications and/or recording devices. While the present invention has applicability to at least these types of communications devices, the principles of the present invention are particularly applicable to all types of communication devices, as well as other devices that process or record speech in noisy environments such as voice recorders, dictation systems, voice command and control systems, and the like. For simplicity, the following description employs the term “telephone” or “cellular telephone” as an umbrella term to describe the embodiments of the present invention, but those skilled in the art will appreciate the fact that the use of such “term” is not considered limiting to the scope of the invention, which is set forth by the claims appearing at the end of this description.

Hereinafter, preferred embodiments of the invention will be described in detail in reference to the accompanying drawings. It should be understood that like reference numbers are used to indicate like elements even in different drawings. Detailed descriptions of known functions and configurations that may unnecessarily obscure the aspect of the invention have been omitted.

The active noise cancellation is done using an adaptive filter the weights of which are adjusted by well known Least Mean Squares (LMS) algorithm as cited in the textbook by Widrow et al.

Other forms of adaptive update algorithms may be used for faster convergence for certain noise conditions.

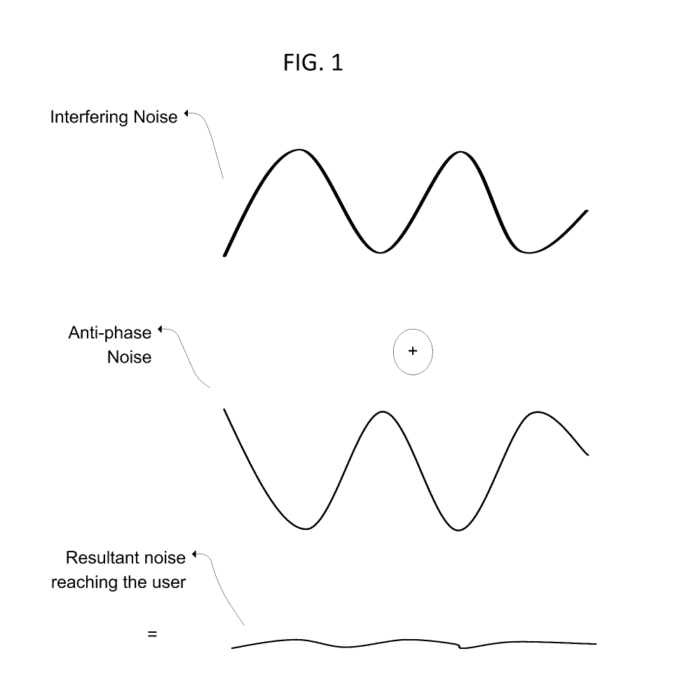

FIG. 1 shows the prior art and the basic principle of an active noise cancellation system. The ambient noise is picked up the reference microphone. Using DSP techniques, an anti-phase signal is generated and transmitted via a loudspeaker. This interferes and cancels the ambient noise thereby reducing the overall effect of it.

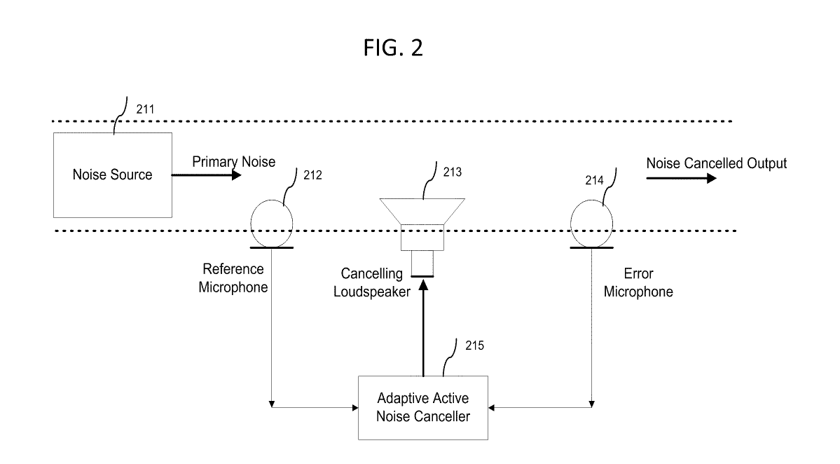

FIG. 2 is diagram of an exemplary embodiment of the active noise cancellation scheme. Block 211 is the source of ambient noise. 212 is the reference microphone which picks up the primary noise. This signal is passed to ANC at 215 which consists of an adaptive filter whose weights are updated using an algorithm like LMS. The ANC generates an anti-phase signal which is sent to the loudspeaker at 113 for playback. The signal from 213 interferes and cancels the primary noise reducing its overall effect. 214 is an error microphone used to pick up the residual signal which is fed back to the ANC. The weights in the adaptive filter are modified so as to minimize the error signal received at the error microphone.

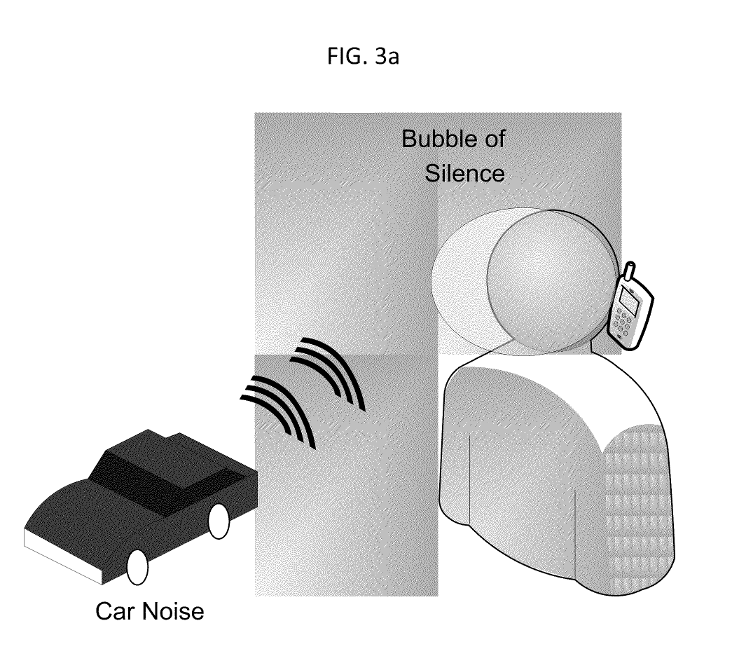

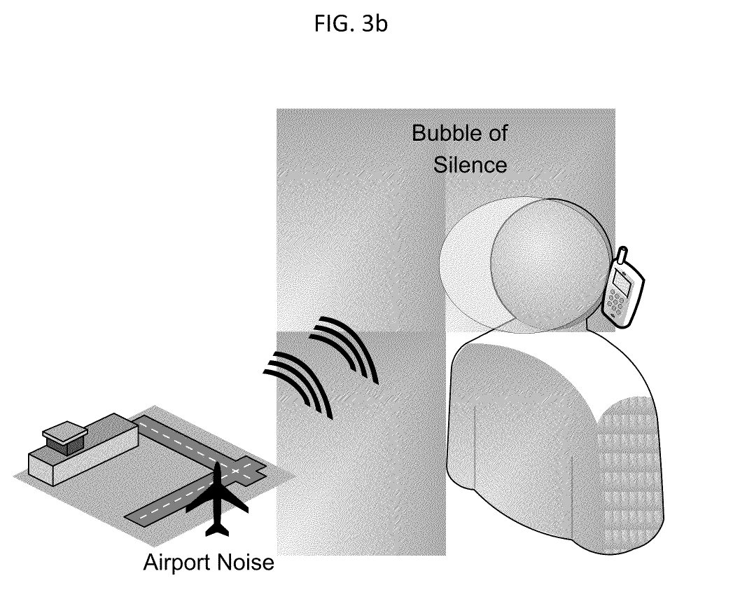

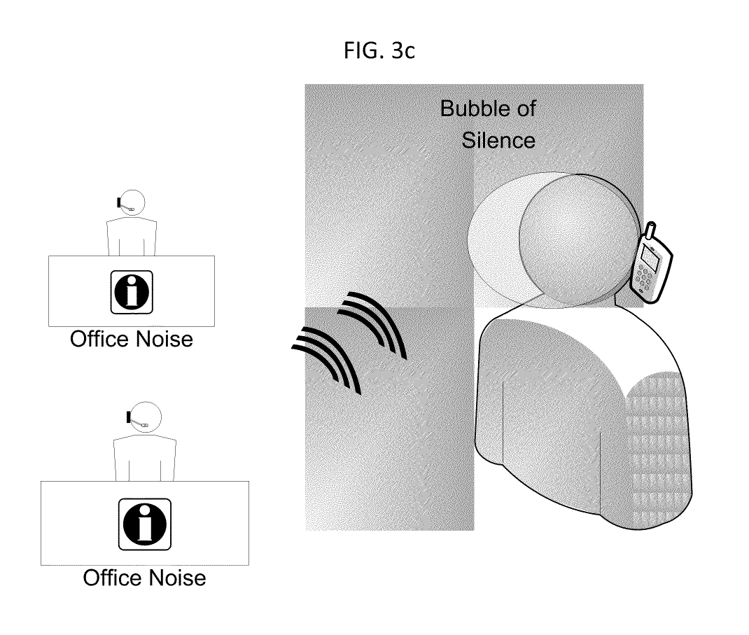

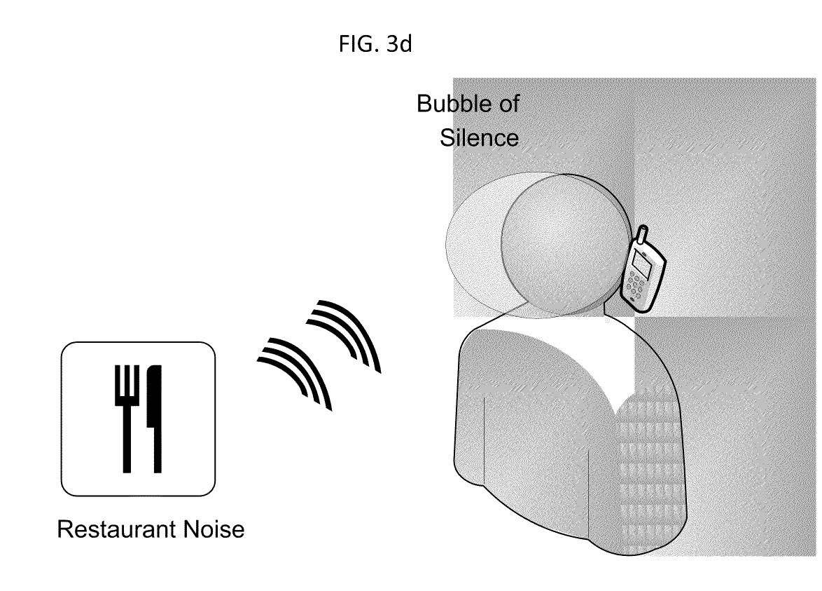

FIG. 3a describes the 3D—silence zone that is created for car noise environment for a voice communication device to have a pleasant conversation and give the user a feeling that he is in a quiet environment.

FIG. 3b describes the 3D—silence zone that is created for airport noise environment for a voice communication device to have a pleasant conversation and give the user a feeling that he is in a quiet environment.

FIG. 3c describes the 3D—silence zone that is created for office noise environment for a voice communication device to have a pleasant conversation and give the user a feeling that he is in a quiet environment.

FIG. 3d describes the 3D—silence zone that is created for restaurant noise environment for a voice communication device to have a pleasant conversation and give the user a feeling that he is in a quiet environment.

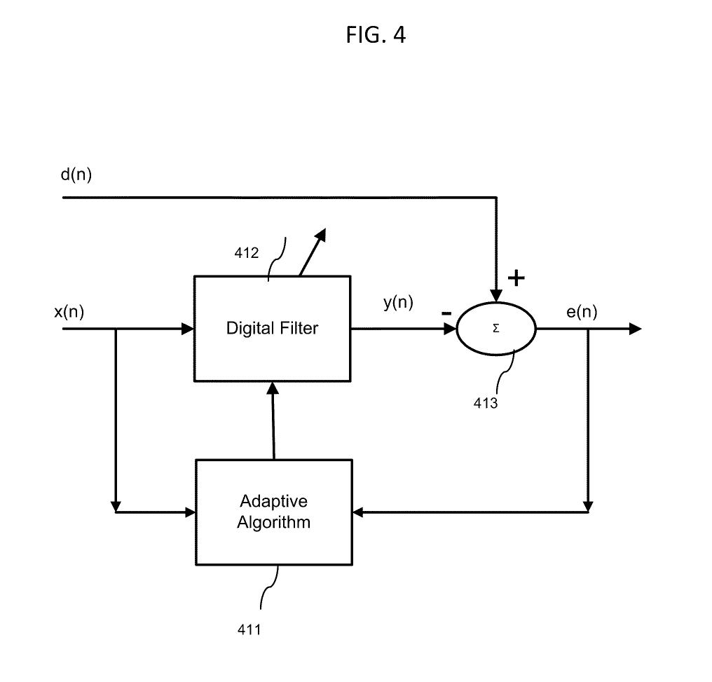

FIG. 4 is a diagram of an exemplary embodiment of the adaptive filter. Block 412 is the digital adaptive filter and 411 calculates the weights required by the adaptive algorithm. d(n) is the desired response and x(n) is the reference input signal. y(n) is the output of the programmable digital filter and e(n), the error signal, is the difference between d(n) and y(n). The weights are chosen so as to minimize the mean square value of e(n).

The output of the digital filter, y(n) and the error signal, e(n) are given by

y(n)=w(n)x(n) (1)

e(n)=d(n)−y(n) (2)

The filter weights are updated using the equation below:

w(n+1)=w(n)+μx(n)e(n) (3)

Where μ is the step size.

As described hereinabove, the invention has the advantage reducing noise in various noisy conditions, enabling the conversation to be pleasant. While the invention has been described with reference to a detailed example of the preferred embodiment thereof, it is understood that variations and modifications thereof may be made without departing from the true spirit and scope of the invention. Therefore, it should be understood that the true spirit and the scope of the invention are not limited by the above embodiment, but defined by the appended claims and equivalents thereof.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

What is claimed is:

1. An active noise cancellation system, the system comprising:
a) a reference microphone which receives primary background noise;
b) an adaptive active noise canceller receiving primary background noise from the reference microphone;
c) the adaptive active noise canceller comprising an adaptive filter system with weights that are updated using a least mean squares method;
d) the adaptive active noise canceller using the primary background noise from the reference microphone and filtering the primary background noise using the adaptive filter system, outputs and anti-phase signal which is sent to a loud speaker for playback;
e) the anti-phase signal produced by the loud speaker cancels or attenuates the primary background noise and leaves a residual signal;
f) an error microphone accepts the residual signal and transmits the residual signal to the adaptive active noise canceller; and
g) the weights of the adaptive filter, within the adaptive active noise canceller are modified by the residual signal.

2. The system of claim 1 wherein adaptive filter system further comprises:
a) a digital adaptive filter and an adaptive algorithm block calculates the weights required an adaptive algorithm, the least mean squares method;
b) wherein d (n) is a desired response, x(n) is a reference input signal, y(n) is an output from the digital adaptive filter;
c) wherein e(n) is the error signal, which may be derived by taking the difference between d(n) and y(n);
d) wherein the adaptive weights are selected so as to minimize the mean square value of e(n);
e) wherein the output of the digital adaptive filter, y(n) and the error signal, e(n) is derived by:
y(n)=w(n)x(n)
and
e(n)=d(n)−y(n);
and
f) wherein the weights of the digital adaptive filter are updated by use of the equation:
w(n+1)=w(n)+μx(n)e(n),
wherein μ is a step size.

3. The system of claim 2 wherein μ is between the value of 0.1 and 0.9.

4. A method of creating a three dimensional area of reduced noise, the method comprising:
a) using a reference microphone to receive a primary background noise;
b) using an adaptive noise canceller to receive the primary background noise from the reference microphone;
c) within the adaptive noise canceller, using an adaptive filter system with weights, with the weights being updated using a least mean squares method;
d) using the adaptive noise canceller to generate an anti-phase signal;
e) using a loud speaker to playback the anti-phase signal in the direction of the primary background noise to create a resulting residual signal; and
f) using an error microphone to accept the residual signal and to transmit the residual signal to modify the weights within the adaptive filter.

5. The method of claim 4 further including the steps of:
a) using a digital adaptive filter and adaptive algorithm block to calculate the weights required for the adaptive algorithm;
b) wherein d (n) is a desired response, x(n) is a reference input signal, y(n) is an output from the digital adaptive filter;
c) wherein e(n) is the error signal, which is derived by taking the difference between d(n) and y(n);
d) selecting the adaptive weights so as to minimize the mean square value of e(n);
e) deriving the output of the digital adaptive filter, y(n) and the error signal, e(n) buy use of the equation:
y(n)=w(n)x(n)
and
e(n)=d(n)−y(n);
and
f) updating the weights of the digital adaptive filter by use of the equation:
w(n+1)=w(n)+μx(n)e(n),
wherein μ is a step size.

6. The method of claim 5, using a value between 0.1 and 0.9 for μ.
